(19) United States
(12) Patent Application Publication
(10) Pub. No.: US 2013/0117263 A1
(43) Pub. Date: May 9, 2013

(54) Context-Based Item Bookmarking

(71) Applicants: Rajan Lukose, Oakland, CA (US); Craig Peter Sayers, Menlo Park, CA (US)

(72) Inventors: Rajan Lukose, Oakland, CA (US); Craig Peter Sayers, Menlo Park, CA (US)

(21) Appl. No.: 13/809,683

(22) PCT Filed: Jul. 22, 2010
(86) PCT No.: PCT/US10/42888

§ 371 Date: Jan. 11, 2013

(51) Int. Cl. G06F 17/30

(52) U.S. Cl. CPC G06F 17/30286
USPC 707/736

(57) ABSTRACT

In a method for context-based item bookmarking (300), an instruction to bookmark an item for future delivery and an action context configured to trigger delivery of the bookmarked item are received (304 and 306). In addition, the action context and the item are bookmarked (308) and at least one entity's activities are monitored to determine whether an activity associated with the action context has been performed (310). Moreover, in response to a determination that the activity associated with the action context has been performed, the bookmarked item is delivered to at least one entity (314).

### BACKGROUND

A number of conventional bookmarking systems exist that enable users interacting with the World Wide Web (“web”) to bookmark items of interest for future revisitation. These bookmarking systems are typically contained within a web browser or online social tagging bookmarking services and allow a user to essentially tag an item to be remembered for later retrieval. In order to assist in the later retrieval, these bookmarking systems allow users to add tags to or to categorize the items using filtered tags or categories. Users have also used other methods for bookmarking the items of interest for future revisitation, such as, by e-mailing a Uniform Resource Locator (URL) of the desired webpage to themselves, in which case the e-mail includes a description (keyword) of the webpage for future recall via a search using an email application or other file searching application.

Users, however, often fail to retrieve the items of interest that have been bookmarked through use of the conventional bookmarking services and other retrieval techniques discussed above, because the users often fail to remember the tags, categories, or keywords that were assigned to the items of interest. In fact, users often forget that they even bookmarked the items of interest in the first place. As such, the conventional bookmarking services and retrieval techniques discussed above often fail to actually support the direct need of the user, which is to enable the user to revisit the (book)marked item when that item is likely to be of interest to the user.

### BRIEF DESCRIPTION OF THE DRAWINGS

Features of the present invention will become apparent to those skilled in the art from the following description with reference to the figures, in which:

FIG. 1 depicts a simplified block diagram of a system for context-based item bookmarking, according to an example embodiment of the invention:

FIG. 2 depicts a simplified block diagram of a system for context-based item bookmarking, according to another example embodiment of the invention;

FIG. 3A shows a flow diagram of a method for context-based item bookmarking, according to an example embodiment of the invention;

FIG. 3B shows a flow diagram of a method for tracking collectively created action contexts and generating metrics, according to an example embodiment of the invention;

FIG. 3C shows a flow diagram of a method for delivering an item to a second entity in response to a determination that an activity configured to trigger the delivery has been performed, according to an example embodiment of the invention; and

FIG. 4 illustrates a computer system, which may be employed to perform various functions of the components depicted in FIGS. 1 and 2 in performing at least some of the steps contained in the flow diagram depicted in FIGS. 3A-3C, according to an example embodiment of the invention.

### DETAILED DESCRIPTION

For simplicity and illustrative purposes, the present invention is described by referring mainly to an example embodiment thereof. In the following description, numerous specific details are set forth in order to provide a thorough understanding of the embodiments. It will be apparent however, to one of ordinary skill in the art, that the present invention may be practiced without limitation to these specific details. In other instances, well known methods and structures have not been described in detail so as not to unnecessarily obscure the present invention.

Disclosed herein are embodiments directed to a method and apparatus for context-based item bookmarking. The method and apparatus disclosed herein enable a user to bookmark an item for revisitation at a future time when the user performs an activity that is associated with a preselected action context. Thus, for instance, the user may bookmark an item, such as, a particular webpage x with an annotation of the form, for example, “deliver the webpage x to me when I am performing activity y”. In this example, the user's activity may be tracked to determine whether the user is performing the activity y and the webpage x may be delivered when a determination that the user is performing the activity y is made. The user may also bookmark an item with an annotation that causes the bookmark item to be delivered to another entity in response to at least one of the user and the another entity performing an activity that is associated with a preselected action context. For example, “show this webpage to any team member who is installing the Eclipse software application”. The user may further bookmark an item to be delivered to themselves when another entity performs an activity. For example, “deliver this takeout restaurant menu to me when my spouse is away”. Moreover, an activity may be a combination of sub-activities performed by different entities. For example “deliver this restaurant review to me when my spouse is at home and I worked late the night before”.

Through implementation of the method and apparatus disclosed herein, the bookmarked item may be delivered to the user or another selected entity at a time when the bookmarked item was originally determined to be of interest to the user or other entity. Thus, for instance, the user need not remember keywords or that the item was previously bookmarked in order to revisit the item when desired.

As used throughout the present disclosure, the term “item” may be defined as including any of a webpage, a Uniform Resource Locator (URL), a hyperlink, an electronic document, a video file, an audio file, an image file, a multimedia file, an email message, a text message, etc. In addition, the terms “action context” may be defined as grammar that is associated with one or more activities, that when performed, trigger delivery of a bookmarked item. Thus, for instance, an action context may define a particular action that is associated with a noun or object, such that, the entity's activities may be monitored to determine whether the particular action on the selected noun or object has been performed by the entity.

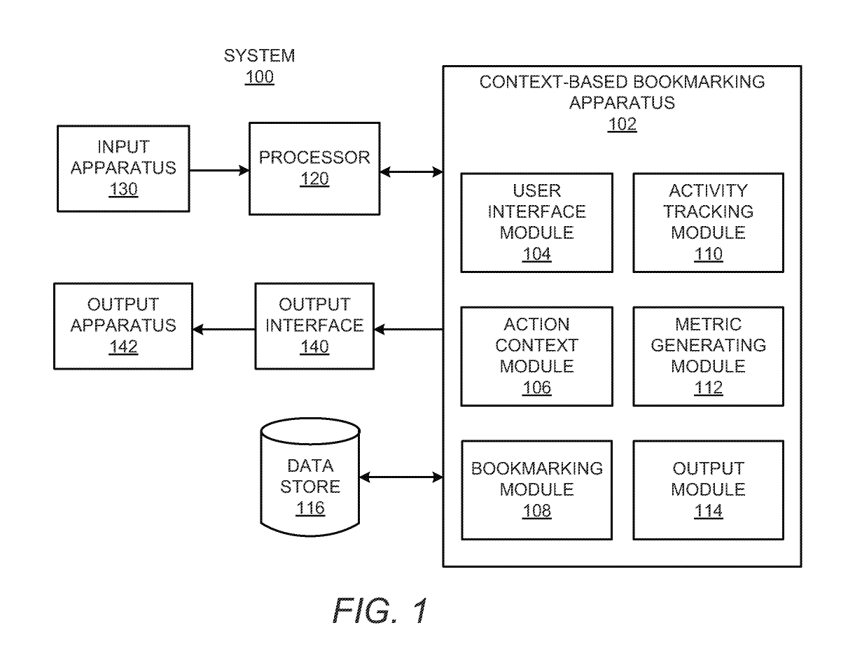

With reference first to FIG. 1, there is shown a simplified block diagram of a system 100 for context-based item bookmarking, according to an example embodiment. It should be understood that the system 100 may include additional components and that some of the components described herein may be removed and/or modified without departing from the scope of the system 100. For instance, the system 100 may include any number of additional applications or software configured to perform any number of other functions discussed with respect to the system 100.

The system 100 comprises a computing device, such as, a personal computer, a laptop computer, a tablet computer, a personal digital assistant, a cellular telephone, etc., configured with a context-based bookmarking apparatus 102 containing a plurality of modules 104-114, a processor 120, an input apparatus 130, a data store 116, an output interface 140, and an output apparatus 142. The processor 120, which may comprise a microprocessor, a micro-controller, an application specific integrated circuit (ASIC), and the like, is configured to perform various processing functions. One of the processing functions includes invoking or implementing the modules 104-114 of the context-based bookmarking apparatus 102 to bookmark items based upon entity-defined context as discussed in greater detail herein below.

According to an example, the bookmarking apparatus 102 comprises a hardware device, such as, a circuit or multiple circuits arranged on a board. In this example, the modules 104-114 comprise circuit components or individual circuits. According to another example, the bookmarking apparatus 102 comprises software stored, for instance, in a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 104-114 comprise software modules stored in the memory. According to a further example, the modules 104-114 of the bookmarking apparatus 102 comprise a combination of hardware and software modules.

The bookmarking apparatus 102 may comprise a plug-in to a browser application, such as, a web browser, which allows access to webpages over an extranet, such as, the Internet or a file browser, which enables the user to browse through files stored locally on the user's system 100 or through files stored externally, for instance, on a shared server. According to another example, the bookmarking apparatus 102 comprises any reasonably suitable application that enables communication over a network, such as, an intranet, the Internet, etc., through the system 100, for instance, an e-mail application, a chat messaging application, a text messaging application, etc. In addition, or alternatively, the bookmarking apparatus 102 may comprise a standalone apparatus or application configured to interact with a messaging application, a browser application, or other types of applications.

As shown in FIG. 1, the bookmarking apparatus 102 includes a user interface module 104, an action context module 106, a bookmarking module 108, an activity tracking module 110, a metric generating module 112, and an output module 114. It should be understood that the bookmarking apparatus 102 may include additional modules and that one or more of the modules 104-114 may be removed and/or modified without departing from a scope of the bookmarking apparatus 102. For instance, one or more of the functions described with respect to particular ones of the modules 104-114 may be combined into one or more of the other modules 104-114.

The bookmarking apparatus 102 is configured to receive input from a user through the input apparatus 130, which may comprise, for instance, a keyboard, a mouse, a touch sensitive screen, a digital pen, or other input mechanism. The input apparatus 130 may also comprise a separate computing device, such as, a personal computer, a laptop computer, a tablet computer, a personal digital assistant, a cellular telephone, a music player, a video player, and the like, configured to interface with the computing device containing the bookmarking apparatus 102. In any regard, a user may use the input apparatus 130 to activate the bookmarking apparatus 102. The user may also use the input apparatus 130 to input an instruction to bookmark an item for future delivery and to also input an action context configured to trigger delivery of the bookmarked item.

According to an embodiment, the user interface module 104 is configured to provide a user interface, which may be displayed on the input apparatus 130. The user interface may include various options that a user may select in inputting the instruction to bookmark an item and one or more action contexts configured to trigger delivery of the bookmarked item. According to an example, the user interface may display a list of available contexts that the bookmarking apparatus 102 has been programmed to recognize. The available contexts may include, for instance, “traveling to”, “shopping for”, “celebrating”, “researching”, “searching for”, “located in”, “watching”, “planning to travel to”, “preparing to”, “likely to be near”, “starting Lo”, “listening to”, etc. The user interface may also include a field into which the user may input a noun associated with the context, in which the noun is configured to cause the bookmarked item to be delivered. Thus, by way of particular example, a user may instruct the bookmarking apparatus 102 to bookmark a particular item to be delivered to the user when the user is “shopping for a new car”. As another particular example, a user may instruct the bookmarking apparatus 102 to bookmark a particular item to be delivered to another entity when the user is “researching a new home”.

The available contexts may be stored in the data store 116, which may comprise volatile and/or non-volatile memory, such as DRAM, EEPROM, MRAM, phase change RAM (PCRAM), Memristor, flash memory, and the like, In addition, or alternatively, the data store 116 may comprise a device configured to read from and write to a removable media, such as, a floppy disk, a CD-ROM, a DVD-ROM, or other optical or magnetic media. In any regard, the bookmarking apparatus 102 may store and access additional data as discussed in greater detail herein below.

The user interface module 104 is configured to access the data store 116 to retrieve the contexts that are provided for selection to a user. In addition, the action context module 106 may be configured to populate the data store 116 and available contexts. Moreover, the action context module 106 may employ a labeled text data source in identifying definitions of nouns inputted by a user. For instance, the action context module 106 may access a large set of nouns from a labeled text data source, which may comprise a third-party database of articles, such as, Wikipedia™, Freebase™, IMDB™, and the like. According to an example, the action context module 106 is configured to associate particular nouns with particular action contexts and to store the associated nouns and action contexts in the data store 116. In this example, the action context module 106 may be configured to cause the user interface to display, for instance, a list of geographic locations or place names when the user selects the context “traveling to”. In addition, the action context module 106 may cause the user interface to display the particular nouns in a hierarchical fashion, which enables the user to select, for instance, a particular city, within a particular state, of a particular country. Additionally, the user interface may employ common interface techniques such as “autocomplete”, which used in many modern search engines for example, so that a user typing the first few characters of the desired city, for example, may result in a drastically narrowed list of choices.

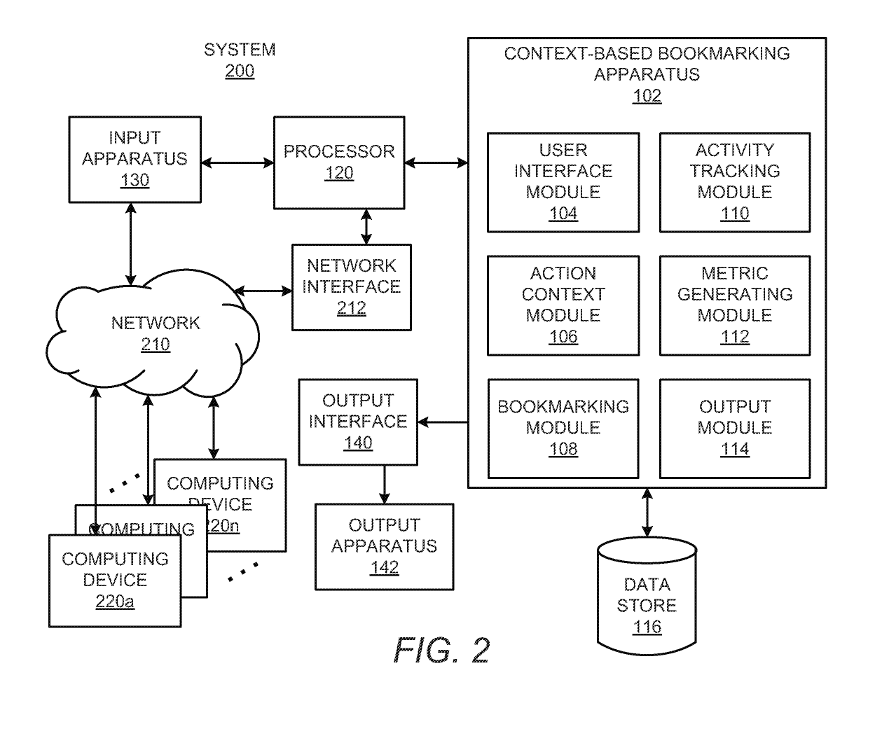

In addition, or alternatively, the action context module 106 may determine the action contexts that are available for selection through the user interface through an analysis of collaborative data pertaining to action contexts specified by a plurality of entities. The entities may include the user and other users. In this regard, and as shown in FIG. 2, the bookmarking apparatus 102 may be in communication with a number of computing devices over a network, such as, the Internet, and may be configured to gather data from the number of computing devices. Thus, for instance, the action context module 106 may determine which of the action contexts specified by the entities are the most common or most popular and may present those action contexts to the user through the user interface. Popularity may here mean, among other things, simply the most popular action contexts chosen by entities (users) (for instance, if the population of users happens to be people who travel often, then, other things being equal, the most likely appropriate action contexts may be travel-related), or the most popular action context determined for specific items (for instance, certain items, regardless of the nature of the general user population might always be associated with certain action contexts, such as a real estate pricing website and the action context “researching a new home”), or some combination thereof. As such, the action contexts may be developed through an analysis of collective actions of multiple entities.

The bookmarking module 108 is configured to store the received action context and the item indicated to be bookmarked to be later delivered to an entity, such as, the user who submitted the instruction to bookmark the item, one or more entities that the user designated to receive the bookmarked item, one or more entities of a group designed to receive the bookmarked item, etc. As discussed above, the item may comprise, for instance, a copy of the item itself or a hyperlink to the item, such as, a URL of the item. In addition, the bookmarking module 108 may store the received action context and the at least one of the item and the reference to the item in the data store 116.

The activity tracking module 110 is configured to track an entity's activities on a computing device, such as, the system 100 and/or the input apparatus 130, to determine whether an activity associated with the action context has been performed by the entity. The entity may include, for instance, the user that bookmarked the action context and the item or an entity other than the user. Thus, in various instances, the activities of multiple entities, including entities other than the user, may be tracked. According to an embodiment, the activity tracking module 110 is configured to track the entity's activities on one or more applications running on the entity's computing device, such as, e-mail applications, Internet browsers, journals, calendars, etc. In addition, or alternatively, the activity tracking module 110 may track the entity's activities on one or more social networking applications, such as, Facebook™, Twitter™, Youtube™, etc. Thus, for instance, the activity tracking module 110 may determine that an entity is “celebrating a friend's birthday” based upon an entry on the entity's Facebook™ page that the entity is going to a particular restaurant to meet with the friend to celebrate the friend's birthday.

In addition or alternatively to directly determining whether the entity's activities are associated with the previously defined action context, the activity tracking module 110 may be configured to infer the entity's activities based upon various collected data. For instance, a list of actions/verbs may be hard-coded for various popular websites, such as, by indicating that “Expedia” is a “booking-travel” type of context, “NY Times™” is a “reading news” type of context, etc. In this example, the full URL, metadata, and/or the content of each visited web page may be analyzed to identify matching nouns from, for instance, a labeled text data source.

According to another embodiment, the activity tracking module 110 is configured to leverage collective intelligence from information gathered from a number of entities, for instance, as gathered and analyzed by the metric generating module 112. The metric generating module 112 is, more particularly, configured to generate one or more metrics pertaining to the bookmarked items and the activities of the entities. By way of example, the metric generating module 112 is configured to generate one or more metrics pertaining to whether a plurality of entities performed activities associated with tracked action contexts. In this example, the metric generating module 112 may determine the percentage of entities that performed the activities associated with the tracked action contexts. As such, for instance, the activity tracking module 110 may make an inference based upon the collective intelligence that entities who view a particular web page are also likely to be planning a trip and may thus infer that the user is likely planning a trip when the user visits that particular web page. The metrics generated by the metric generating module 112 may also be helpful, for instance, to advertisers in identifying habits of entities that visit various web pages.

The output module 114 is configured to deliver the bookmarked item to one or more entities in response to a determination that one or more activities associated with a previously defined action context have been performed. As shown in FIG. 1, the system 100 includes an output interface 140 and an output apparatus 142 through which the bookmarking apparatus 102 is configured to provide the bookmarked item to the one or more entities. In this regard, the output module 114 may access the bookmarked item stored in the data store 116 to provide bookmarked item to the one or more entities. In addition, the output apparatus 142 may comprise, for instance, a display monitor, a computing device, etc., upon which an entity may view the delivered bookmarked item. Moreover, the output interface 140 may comprise any suitable hardware and/or software configured to enable the one or more entities to access the bookmarked item or the bookmarked reference to the item.

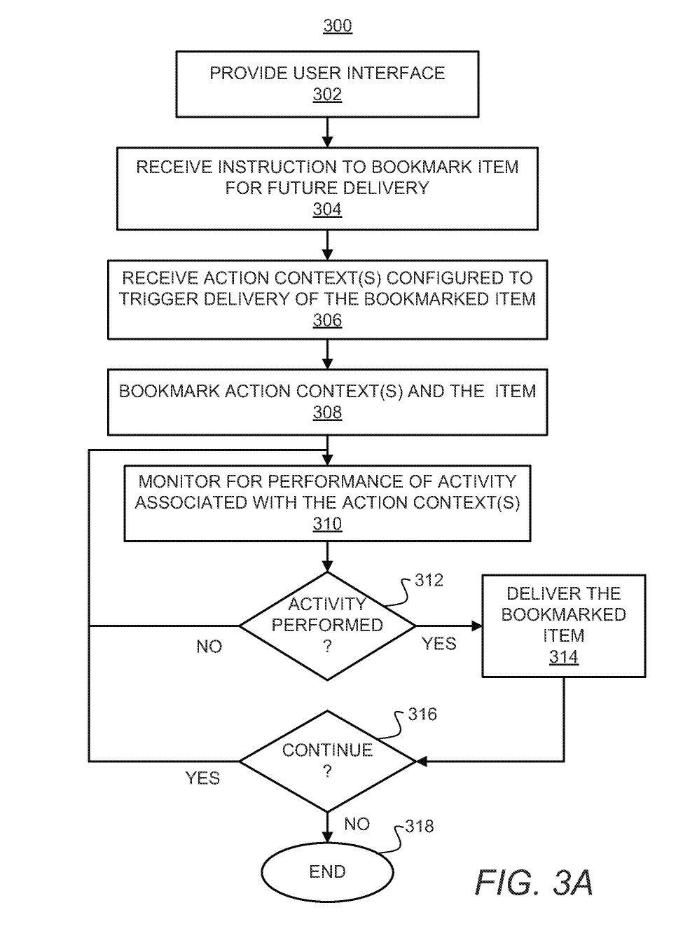

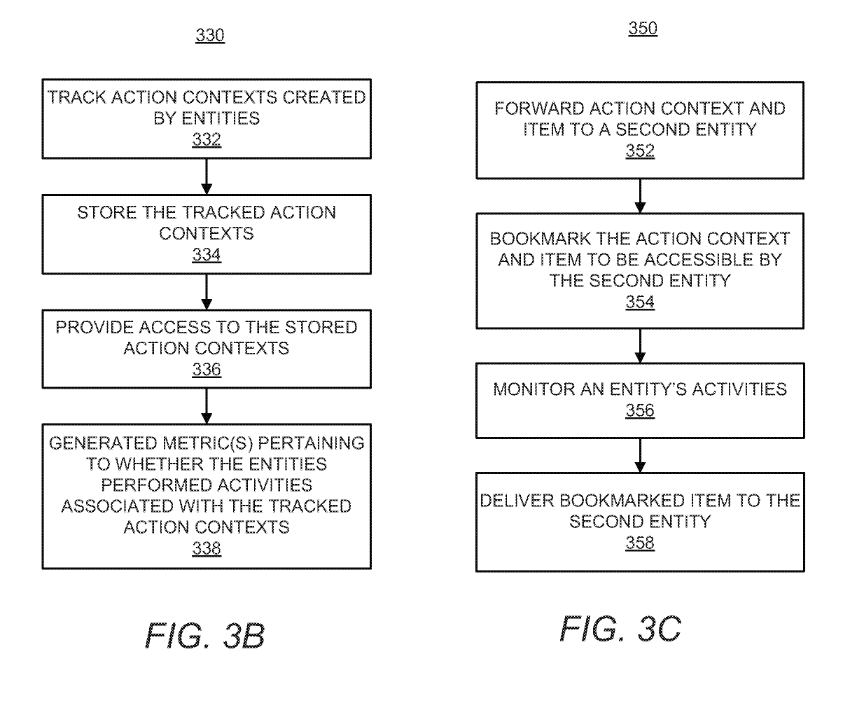

Various manners in which the modules 104-114 of the bookmarking apparatus 102 may operate is discussed in greater detail with respect to the method 300 depicted in FIG. 3A. Initially, however, reference is made to FIG. 2, which shows a simplified block diagram of a system 200 for context-based item bookmarking, according to another example embodiment. It should be understood that the system 200 may include additional components and that some of the components described herein may be removed and/or modified without departing from the scope of the system 200. For instance, the system 200 may include any number of additional applications or software configured to perform any number of other functions discussed with respect to the system 200.

As shown in FIG. 2, the system 200 includes, in addition to the components described above with respect to FIG. 1, a network 210, a network interface 212, and plurality of computing devices 220a-220n. According to a first example, the processor 120, the input apparatus 130 and the context-based bookmarking apparatus 102 form part of a computing device that is local to a first user. In this example, the modules 104-114 comprise hardware and/or software modules contained in the first user's local computing device. In a second example, the processor and the bookmarking apparatus 102 form part of a computing device that is remote from the first user, such as, a server. In this example, the modules 104-114 comprise hardware and/or software contained in the remote computing device that the first user may access through a networked connection between the input apparatus 130 and the remote computing device.

As discussed in greater detail herein below with respect to the method 300, the bookmarking apparatus 102 may receive instructions and action contexts from a first user through the input apparatus 130 and/or from one or more other entities through the computing devices 220a-220n. In addition, the bookmarking apparatus 102 may collect data pertaining to the action contexts entered into the bookmarking apparatus 102 and may track the activities performed by the entities through the network 210, which may comprise the Internet. Moreover, the bookmarking apparatus 102 may deliver the bookmarked item to one or more of the entities in response to one or more of the entities determined to have performed an activity associated with one or more submitted action contexts.

With reference now to FIG. 3A, there is shown a flow diagram 300 of a method for context-based item bookmarking, according to an example embodiment. It should be apparent to those of ordinary skill in the art that the method 300 represents a generalized illustration and that other steps may be added or existing steps may be removed, modified or rearranged without departing from a scope of the method 300. Although particular reference is made to the systems 100 and 200 depicted in FIGS. 1 and 2 as comprising environments in which the steps outlined in the method 300 may be performed, it should be understood that the method 300 may be performed in differently configured systems without departing from a scope of the method 300.

At step 302, a user interface is provided to an entity, for instance, by the user interface module 104. As discussed above, the entity may comprise a first user connected directly to a computing device having the bookmarking apparatus 102 or another user connected through a network 210 to the computing device having the bookmarking apparatus 102. In addition, the user interface may provide the entity with a number of active contexts from which the entity may select to trigger delivery of the bookmarked item, as discussed above. As discussed above with respect to FIG. 1, the action contexts created by a plurality of entities may be tracked, as indicated at step 332 in FIG. 3B, which illustrates a method 330 for tracking collectively created action contexts and generating metrics, according to an example. In addition, at step 334, the tracked action contexts may be stored and at step 336, access to the stored action contexts may be provided to one or more entities for use, for instance, in inputting the action context at step 306. As also discussed above, the action contexts provided to the entities may comprise, for instance, the action contexts determined through an analysis of collective actions of the entities to be the most popular among the entities. In addition, at step 338, one or more metrics pertaining to whether the entities performed activities associated with the tracked action contexts may be generated as further discussed above.

At step 304, an instruction to bookmark an item for future delivery is received through, for instance, the user interface provided by the user interface module 104. By way of example, when an entity desires to revisit a particular webpage at a future time when, for instance, the particular webpage will likely be of interest to the entity, the entity may input an instruction to bookmark that particular webpage through the user interface provided at step 302.

At step 306, one or more action contexts configured to trigger delivery of the bookmarked item are received through, for instance, the user interface provided by the user interface module 104. As discussed above, the entity may be provided with the available action contexts through the user interface and the entity may name one or more of the available action contexts to trigger delivery of the bookmarked item. In addition, the action context(s) may include one or more nouns, as discussed above. As a particular example, the entity may determine that a webpage directed to fine Indian cuisine would be of interest to the entity when the entity is in a particular city and may thus wish to bookmark that webpage for revisitation, for instance, when the entity is located in that particular city.

As another example, a first entity may determine that an electronic document would be of interest to one or more other entities when either or both of the entity and the one or more other entities perform an activity associated with the action context(s). In this example, for instance, the first entity may input action context(s) configured to cause the bookmarked item to be delivered to the one or more other entities in response to an activity associated with the action context(s) being performed. As a particular example, the first entity and the one or more other entities may be included in a group working collaboratively on a project and the first entity may determine that a particular electronic document would be of interest to the members of the group when those members perform a particular activity.

As discussed in greater detail above with respect to the action context module 106, the action context(s) inputted by a plurality of entities may be tracked and certain ones of the tracked action context(s) may be provided for selection to the one or more entities. In addition, one or more metrics pertaining to whether the plurality of entities performed activities associated with the tracked action contexts may be generated, for instance, by the metric generating module 112, and may be used in determining which of the action contexts are presented to the entities.

At step 308, the action context(s) and the item are bookmarked, for instance, by the bookmarking module 108. According to an example, the bookmarking module 108 is configured to store the action context(s) and the item in the data store 116. In addition or alternatively, the bookmarking module 108 is configured to store the action context(s) and the item in remote storage location. In addition, the bookmarking module 108 may forward the bookmarked action context and item to a second entity's computing device to be stored there locally.

At step 310, at least one entity's activities are monitored, for instance, by the activity tracking module 110. As discussed above, the at least one entity's activities may be monitored through monitoring of the at least one entity's activities on a computing device or on one or more websites, such as social networking websites. In addition, the activities of the entity that instructed the item to the bookmarked and/or the activities of other entities, for instance, entities designated to receive the bookmarked item, maybe monitored at step 310.

At step 312, a determination as to whether an activity associated with the action context(s) has been performed is made, for instance, by the activity tracking module 110. As an example, the activity tracking module 110 may track and entity's entries into a social networking website and may determine the entity's status based upon the entries. Thus, for instance, the activity tracking module 110 may determine that the entity is at a particular location based upon an entry by the entity that the entity is in a particular city. In this example, if the entity inputted an action context to deliver the bookmarked item when the entity is located in the particular city, the activity tracking module 110 may determine that the condition for the action context has been satisfied and made this determine that the activity associated with the action context has been performed at step 312. The activity tracking module 110 may also determine the entity's location through use of other electronic means, such as, global positioning satellite (GPS) coordinates of the entity's computing device.

In response to a determination that an activity associated with the action context(s) has not been performed, the at least one entity's activities may continue to be monitored as indicated at step 310. In addition, the at least one entity's activities may be continuously monitored until a determination that an activity associated with the action context(s) has been performed at step 312 is made. In response to a determination that an activity associated with the action context has been performed, the bookmarked item is delivered to the at least one entity, for instance, by the output module 114, as indicated at step 314. In other examples, the bookmarked item is delivered to the computing devices 220a-220n of one or more other entities, for instance, over the network 210. In yet other examples, the bookmarked item is delivered to a computing device of the entity that differs from the computing device through which the entity inputted the instruction to bookmark the item.

At step 316, a determination as to whether the method 300 is to be continued is made. The method 300 may be continued, for instance, if an entity selects for the bookmarked item to be delivered following performance of the activity by the entity or by another entity. Thus, for instance, the method 300 may be continued in situations in which the bookmarked item is to be delivered to multiple entities as the entities perform the activity associated with the action context(s). In response to the determination that the method 300 is to be continued, steps 310-316 may be repeated until a determination is made at step 316 that the method 300 is to be discontinued. The determination to discontinue the method 300 may be made, for instance, following expiration of a predetermined length of time, following performance of a number of iterations, following delivery of the bookmarked item to each of the entities of designated to receive the bookmarked item, etc. In any regard, the method 300 may end following the “no” condition at step 316, as indicated at step 318.

According to a particular example, a first entity may wish to have an item delivered to a second entity in response to a determination that an activity performed by at least one entity, which may include the first entity, the second entity, or another entity, is associated with the action context identified at step 306. This example is depicted in FIG. 3C, which illustrates a flow diagram of a method 350 according to an example embodiment. As shown therein, at step 352, the action context and the item to be bookmarked as received at steps 304 and 306 in FIG. 3, are forwarded to a second entity. At step 354, the action context and the item are bookmarked in a location to be accessible by the second entity. In addition, at step 356, an entity's activities are tracked, which may include tracking at least one of the activities of the first entity, the second entity, and another entity. Moreover, at step 358, the bookmarked item is delivered to the second entity in response to a determination that an activity associated with the action context has been performed.

At least some of the operations set forth in the methods 300, 330, and 350 may be contained as one or more utilities, programs, or subprograms, in any desired computer accessible or readable medium. In addition, the methods 300, 330, and 350 may be embodied by a computer program, which may exist in a variety of forms both active and inactive. For example, it can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, phase change RAM (FORAM), Memristor, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

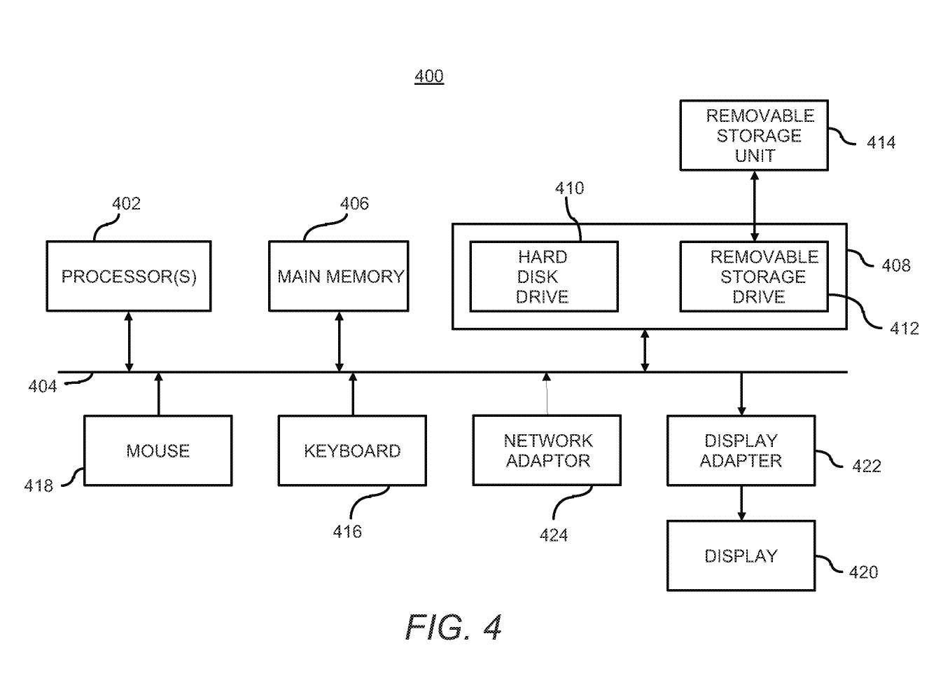

FIG. 4 illustrates a computer system 400, which may be employed to perform the various functions of the components depicted in the systems 100 and 200 described herein above, according to an example. In this respect, the computer system 400 may be used as a platform for executing one or more of the functions described hereinabove with respect to the methods 300, 330, and 350.

The computer system 400 includes a processor 402, which may be used to execute at least some of the steps described in the methods herein. Commands and data from the processor 402 are communicated over a communication bus 404. The computer system 400 also includes a main memory 406, such as a random access memory (RAM), where the program code may be executed during runtime, and a secondary storage 410. The secondary storage may comprise, for example, a hard drive or other non volatile memory, where a copy of the program code for context-based item bookmarking may be stored.

The computer system 400 may comprise a server having a web interface. Alternately, the computing system 400 may be configured with user input and output devices including a keyboard 416, a mouse 418, and a display 420. A display adaptor 422 may interface with the communication bus 404 and the display 420 and may receive display data from the processor 402 and convert the display data into display commands for the display 420. In addition, the processor 402 may communicate over a network, for instance, the Internet, LAN, etc., through a network adaptor 424.

It will be apparent to one of ordinary skill in the art that other known electronic components may be added or substituted in the computer system 400. In addition, the computer system 400 may include a system board or blade used in a rack in a data center, a conventional “white box” server or computing device, etc. Also, one or more of the components in FIG. 4 may be optional (for instance, user input devices, secondary memory, etc.).

That has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which the terms are meant in their broadest reasonable sense unless otherwise indicated.

What is claimed is:

1. A method (300) for context-based item bookmarking, said method comprising:
receiving an instruction (304) to bookmark an item for future delivery;
receiving an action context (306) configured to trigger delivery of the bookmarked item;
bookmarking the action context and the item (308);
monitoring at least one entity's activities to determine whether an activity associated with the action context has been performed (310); and
in response to a determination that the activity associated with the action context has been performed, delivering the bookmarked item to at least one entity (314).

2. The method (300) according to claim 1, further comprising:
providing a user interface (302) through which the instruction and the action context are received from one or more entities, wherein the user interface is associated with a database that stores a plurality of action contexts, and wherein providing the user interface (302) further comprises providing the one or more entities with access to the plurality of action contexts stored on the database.

3. The method (300) according to claim 2, further comprising:
tracking action contexts created by a plurality of entities (332);
storing the tracked action contexts in the database (334); and
wherein providing the one or more entities with access to the plurality of action contexts comprises providing the one or more entities with access to the tracked action contexts (336).

4. The method (300) according to claim 3, further comprising:
generating one or more metrics pertaining to whether the plurality of entities performed activities associated with the tracked action contexts (338).

5. The method (300) according to claim 1, wherein monitoring the at least one entity's activities (310) further comprises monitoring the at least one entity's activity on a computing device and determining whether the at least one entity's activity on the computing device is associated with the action context.

6. The method (300) according to claim 1, wherein receiving the instruction to bookmark the item (304) further comprises receiving the instruction from a first entity (304), wherein monitoring the at least one entity's activities (310) further comprises monitoring the at least one entity's activities (310) to determine whether at least one of the first entity and a second entity performed the activity, and wherein delivering the bookmarked item (314) further comprises delivering the bookmarked item to at least one of the first entity and the second entity in response to a determination that the at least one of the first entity and the second entity performed the activity (314).

7. The method (300) according to claim 6, wherein monitoring the at least one entity's activities (310) further comprises monitoring the at least one entity's activities on one or more social networking applications to determine whether the at least one entity performed the activity associated with the action context (310).

8. The method (300) according to claim 1, wherein the action context is associated with an activity that is operable to be performed by a plurality of entities, wherein monitoring (310) further comprises monitoring activities of the plurality of entities to determine whether the activity associated with the action context has been performed by one or more of the plurality of entities (310), and wherein delivering further comprises delivering the bookmarked item to the one or more of the plurality of entities determined to have performed the activity (314).

9. The method (300) according to claim 1, wherein receiving the instruction (304) and the action context (306) further comprises receiving the instruction and the action context from a first entity, said method further comprising:
forwarding the action context and the item to a second entity (352);
bookmarking the action context and the item to be accessible by the second entity (354); and
wherein monitoring (310) further comprises monitoring at least one entity's activities to determine whether an activity associated with the action context has been performed (356) and wherein delivering further comprises delivering the bookmarked item to the second entity in response to a determination that the activity associated with the action context has been performed (358).

10. An apparatus for context-based item bookmarking (102), said apparatus comprising:
one or more modules (104-114) configured to receive an instruction to bookmark an item for future delivery, to receive an action context configured to trigger delivery of the bookmarked item, to bookmark the action context and the item, to monitor at least one entity's activities to determine whether an activity associated with the action context has been performed, and to deliver the bookmarked item to at least one entity in response to a determination that the activity associated with the action context has been performed; and
a processor (120) configured to implement the one or more modules.

11. The apparatus (102) according to claim 10, wherein the one or more modules (104-114) are further configured to provide a user interface through which the instruction and the action context are received from at least one entity, wherein the user interface is associated with a database that stores a plurality of action contexts, and wherein the user interface is configured to provide the at least one entity with access to the plurality of action contexts stored on the database.

12. The apparatus (102) according to claim 10, wherein the one or more modules (104-114) are further configured to track action contexts created by a plurality of entities, to store the tracked action contexts in the database, and to provide the at least one entity with access to the tracked action contexts.

13. The apparatus (102) according to claim 10, wherein the one or more modules (104-114) are further configured to receive the instruction from a first entity, to determine whether at least one of the first entity and a second entity performed the activity, and to deliver the bookmarked item to at least one of the first entity and the second entity in response to a determination that the at least one of the first entity and the second entity performed the activity.

14. The apparatus (102) according to claim 10, wherein the action context is associated with an activity that is operable to be performed by a plurality of entities, wherein the one or more modules (104-114) are further configured to monitor activities of the plurality of entities to determine whether the activity associated with the action context has been performed by one or more of the plurality of entities, and to deliver the bookmarked item to the one or more of the plurality of entities that have been determined to have performed the activity.

15. A computer readable storage medium (410, 414) on which is embedded one or more computer programs, said one or more computer programs implementing a method for context-based item bookmarking (300), said one or more computer programs comprising computer readable code for:
receiving an instruction (304) to bookmark an item for future delivery;
receiving an action context (306) configured to trigger delivery to the bookmarked item;
bookmarking the action context and the item (308);
monitoring at least one entity's activities to determine whether an activity associated with the action context has been performed (310); and
in response to a determination that the activity associated with the action context has been performed, delivering the bookmarked item to at least one entity (314).
